(19) United States
(12) Patent Application Publication
(10) Pub. No.: US 2004/0047262 A1
(43) Pub. Date: Mar. 11, 2004

(54) High-density optical disc and method for recording/reproducing data thereof

(76) Inventors: Sang Woon Suh, Seoul (KR); Ik Beom Jeon, Seoul (KR)

Correspondence Address: HARNESS, DICKEY & PIERCE, P.L.C., P.O. BOX 8910, RESTON, VA, 20195, US

(21) Appl. No.: 10/644,741

(22) Filed: Aug. 21, 2003

(30) Foreign Application Priority Data
Aug. 22, 2002 (KR) 10-2002-0049638

(51) Int. Cl. G11B 7/00

(52) U.S. Cl. 369/53.21

(57) ABSTRACT

A high-density optical disc and a method for recording/reproducing data of the high-density optical disc are disclosed. Playback allowance codes adapted to determine region-based allowance of playback of data recorded on the optical disc are recorded in a part of user control data, having a predetermined recording size, recorded on the optical disc. When a data reproducing operation for the optical disc is carried out in an optical disc apparatus, a region-based playback allowance code corresponding to the intrinsic region identification information previously stored in the optical disc apparatus is detected from the user control data. The detected code is used as a de-scrambling key for an address unit number or user data to be read from the optical disc. Accordingly, it is possible to more efficiently achieve region-based protection of the copyright of a high-density optical disc.

### BACKGROUND OF THE INVENTION

1. Field of the Invention

The present invention relates to a high-density optical disc, and more particularly to a high-density read-only optical disc, such as BD-ROM (Blu-ray Disc Read Only Memory), additionally recorded with a playback allowance region code for selectively allowing playback of the optical disc in accordance with regions, and a method for recording/reproducing data of the high-density optical disc.

2. Description of the Related Art

Recently, high-density optical discs have been developed, for example, DVD (Digital Versatile Disc), which can store a large quantity of high-quality video and audio data. Currently, such high-density optical discs are widely commercially available.

On a DVD, main A/V data is recorded in the unit of sectors each having a size of 2,048 bytes, as shown in FIG. 1. In each sector of 2,048 bytes, additional information of 16 bytes is recorded which may include ID (Identification Data), IED (ID Error Detection Code), CPR_MAI (Copyright Management Information), and EDC (Error Detection Code).

The CPR_MAI, which is included in the additional information, consists of 6 bytes including 1-byte CPS_TY (Copyright Protection System Type) information, 4-byte reserved information, and 1-byte RMA (Region Management) information, as shown in FIG. 2.

The 1-byte RMA information includes 1-bit RMA flags RMA #1 to RMA #8 respectively representing, for different regions, whether or not playback of an associated DVD is allowed.

For example, where it is assumed that the first bit of the 1-byte RMA information, RMA #1, is associated with the American continents while being set to ‘0b’, whereas the remaining second through eighth bits of the 1-byte RMA information, RMA #2 to RMA #8, are set to ‘1b’, the DVD can be played back in the American continents while being prevented from being played back in regions other than the American continents.

Meanwhile, an optical disc apparatus, which is adapted to play back the above-mentioned DVD, previously stores intrinsic region identification information for regions where the optical disc apparatus may be sold and used, for example, region identification information corresponding to the RMA information of the DVD. For instance, where region identification information associated with the American continents is stored in the optical disc apparatus, it is possible to normally play back a DVD in which the first-bit RMA flag RMA #1 is set to ‘0b’.

Also, where the optical disc apparatus stores region identification information associated with Asian regions, it cannot play back the DVD in which only the first-bit RMA flag RMA #1 is set to ‘0b’.

Accordingly, it is possible to prevent unauthorized playback of a DVD in regions where use of the DVD is not permitted.

However, where the intrinsic region identification information previously stored in the optical disc apparatus is changed into a code free condition to allow the optical disc apparatus to play back a DVD irrespective of regions, or the optical disc apparatus is controlled to skip an operation for comparing the intrinsic region identification information with the RMA information recorded on the DVD, there is a problem in that a copyright protecting operation cannot be carried out.

Meanwhile, standardization of new high-density read-only optical discs such as BD-ROM has recently been conducted by associated companies. However, there is no method for effectively protecting copyrights of such high-density read-only optical discs in accordance with regions. Accordingly, such a method is strongly demanded.

### SUMMARY OF THE INVENTION

The present invention has been made in view of the above-mentioned problems, and an object of the invention is to provide a high-density optical disc and a method for recording/reproducing data of the high-density optical disc, which are capable of efficiently protecting the copyright of the optical disc in accordance with regions.

In accordance with one aspect, the present invention provides a high-density recording medium, comprising: at least one playback allowance code, which is adapted to determine region-based allowance of playback of data recorded on the recording medium, while being recorded in a part of user control data, having a predetermined recording size, recorded on the recording medium.

In accordance with another aspect, the present invention provides a method for reproducing data of a high-density recording medium, comprising the steps of: (A) identifying region identification information stored in a recording/reproducing apparatus, and detecting a region-based playback allowance code, corresponding to the identified region identification information, from user control data recorded on the recording medium; and (B) de-scrambling a scrambled address unit number read from the optical disc, based on the detected playback allowance code, and performing a data reproducing operation by referring to the de-scrambled address unit number.

### BRIEF DESCRIPTION OF THE DRAWINGS

The above objects, and other features and advantages of the present invention will become more apparent after reading the following detailed description when taken in conjunction with the drawings, in which:

FIG. 1 is a schematic view illustrating the structure of a data frame in a general DVD; FIG. 2 is a schematic view illustrating the structure of CPR_MAI in a general DVD;

FIG. 3 is a schematic view illustrating the structure of an access block in a high-density optical disc according to the present invention;

FIG. 4 is a schematic view illustrating the user control data and region key table in the high-density optical disc according to the present invention; and

FIG. 5 is a schematic block diagram illustrating an encoding procedure in manufacturing the high-density optical disc according to the present invention, and a decoding procedure in reproducing data of the high-density optical disc in an optical disc apparatus.

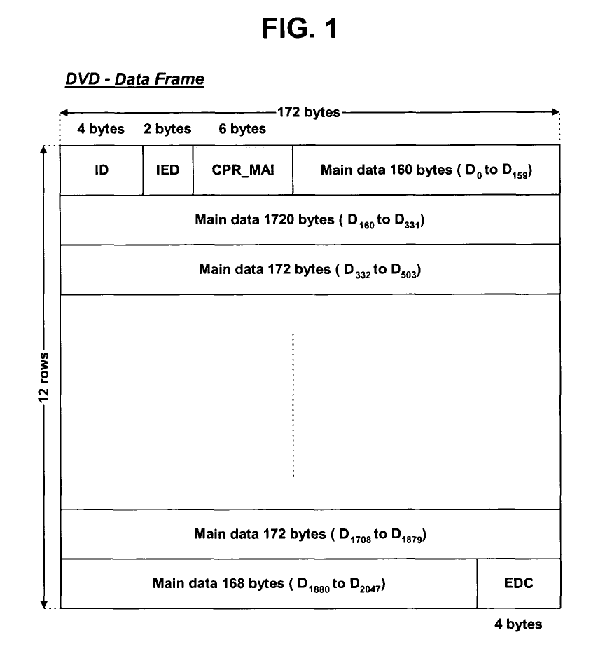

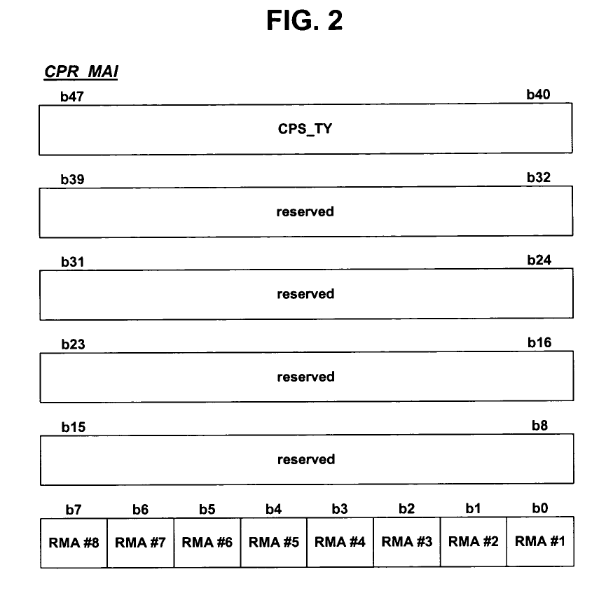

### DETAILED DESCRIPTION OF PREFERRED EMBODIMENTS

Hereinafter, preferred embodiments of a high-density optical disc and a method for recording/reproducing data of the high-density optical disc according to the present invention will be described in detail with reference to the annexed drawings.

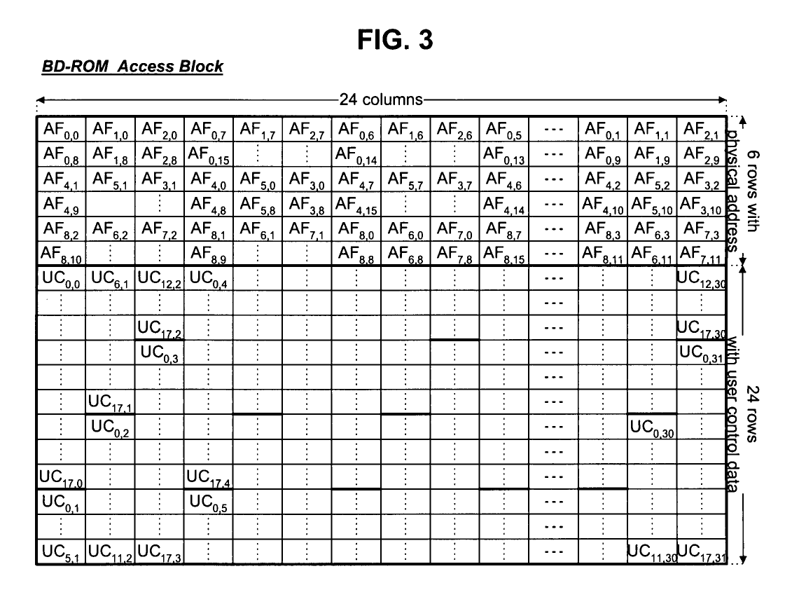

The high-density optical disc according to the present invention, which may be a BD-ROM, may be recorded with physical address data having a size of 24 columns×6 rows (bytes), and user control data having a size of 24 columns×24 rows (bytes) in a single access block thereof, as shown in FIG. 3.

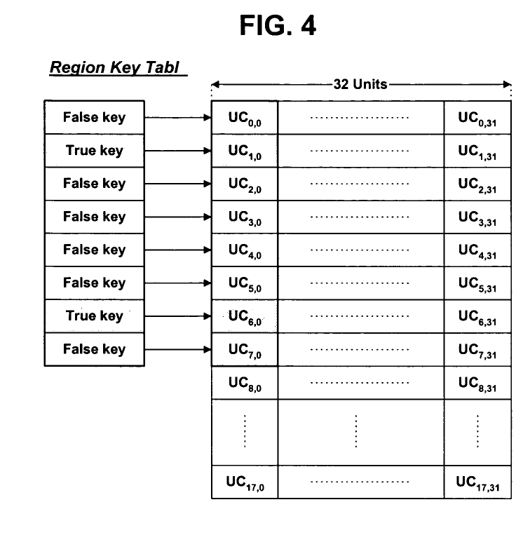

The user control data has a size of 32 units×18 rows (bytes) before it is recorded in the access block, as shown in FIG. 4. In a part of this user control data, for example, respective first-byte user control data fields of the first through eighth rows, UC_{0,0}, UC_{1,0}, UC_{2,0}, . . . , UC_{7,0}, at least one playback allowance code is recorded for determination of region-based playback for the optical disc.

The playback allowance code is recorded in the form of an enciphering key for scrambling or de-scrambling address unit number recorded in the access block, for example, a region key. In this case, in accordance with a selection by the contents provider, as shown in FIG. 4, a true key adapted to normally de-scramble the address unit number is recorded, for example, in the first-byte user control data fields UC_{1,0} and UC_{6,0} of the second and seventh rows in the user control data, whereas a false key adapted to prevent the address unit number from being normally de-scrambled is recorded in the remaining first-byte user control data fields UC_{0,0}, UC_{2,0}, UC_{3,0}, UC_{4,0}, UC_{5,0} and UC_{7,0.}

That is, the contents provider manufacturing and selling the above-described BD-ROM records the true key in the user control data field corresponding to a selected particular region, while recording the false key in the user control data fields respectively corresponding to regions other than the particular region. Accordingly, it is possible to prevent the BD-ROM from being illegally played back in an optical disc apparatus sold and used in a region where use of the BD-ROM is not permitted.

Meanwhile, the particular region may be set, taking into consideration the region numbers 1 to 8 (not shown) defined in the DVD. Also, the true key is not limited to a single particular region. Two true keys may be recorded to allow playback of a title in two regions. In this case, it is possible to provide convenience where neighboring nations, between which traffic is heavy and easily conducted, are set to different region numbers, respectively.

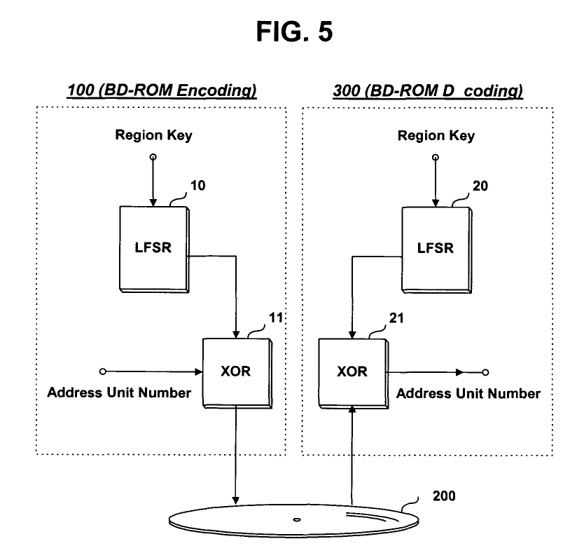

FIG. 5 schematically illustrates an encoding procedure in manufacturing a high-density optical disc, and a decoding procedure in reproducing data of the high-density optical disc in an optical disc apparatus.

In a procedure of manufacturing a BD-ROM, the contents provider randomizes region keys corresponding to respective regions by use of a linear feedback shift register 10, and then logically combines the randomized region keys with an address unit number by use of an exclusive OR (XOR) element 11 so as to scramble the address unit number by the region key associated with a selected region. The scrambled address unit number is then recorded on the BD-ROM.

As described above with reference to FIG. 4, the region key used in the scrambling process is also recorded in the first-byte user control data fields UC_{0,0}, UC_{1,0}, . . . , UC_{7,0} of the first through eighth rows of the access block. In this case, the contents provider records the region key used in the scrambling process, that is, a true key, in the user control data field corresponding to the region where use of the BD-ROM is permitted, while recording an optional region key not used in the scrambling process, that is, a false key, in the user control data fields respectively corresponding to regions where use of the BD-ROM is not permitted.

Meanwhile, a piece of region identification information is previously stored in an optical disc apparatus adapted to play back the above-described BD-ROM. In this case, the region identification information is intrinsic identification information for a particular region where the optical disc apparatus may be sold and used. This region identification information is used to search the BD-ROM for a desired region key.

The region identification information is not limited to a single piece. It is preferable to store the region identification information in up to 2 pieces.

The optical disc apparatus includes the XOR element 21 and linear feedback shift register 10, as shown in FIG. 5. In accordance with this configuration, upon playing back the BD-ROM, the optical disc apparatus first identifies the intrinsic region identification information previously stored therein, and detects a region key, corresponding to the identified intrinsic region identification information, from the user control data fields of the BD-ROM.

The optical disc apparatus randomizes the detected region key through the linear feedback shift register 20, and then XORs the randomized region key with a scrambled address unit number read from the BD-ROM, thereby de-scrambling the scrambled address unit number into an original unit number.

Referring to the address unit number de-scrambled in the above-described procedure, the optical disc apparatus performs a normal data reproducing operation. If the region key corresponding to the intrinsic region identification information previously stored in the optical disc apparatus is a false key not used in the scrambling process, the optical disc apparatus cannot perform a normal data reproducing operation because no normal de-scrambling operation for the scrambled address unit number is carried out.

Where it is desired to allow playback of the high-density optical disc irrespective of regions, the region key used in the scrambling process, that is, the true key, is recorded in the user control data fields corresponding to respective regions.

For reference, the region key may be not only used to encipher the address unit number and decipher the enciphered address unit number, but also to encipher user data such as A/V data and decipher the enciphered user data.

Although the present invention has been described mainly in conjunction with the procedure of manufacturing the high-density optical disc or reproducing data of the high-density optical disc, it may be applicable to a procedure of recording data on a recordable high-density optical recording medium. Also, region limitation information may be recorded in a similar manner to that used in manufacturing the optical disc so that it is used to achieve enciphering (for example, scrambling) of data.

As apparent from the above description, in accordance with a high-density optical disc and a method for recording/reproducing data of the high-density optical disc in accordance with the present invention, it is possible to prevent an optical disc player from skipping an operation of comparing intrinsic region identification information stored in the optical disc player with region management information recorded on the optical disc to be played back. Even when the region identification information stored in the optical disc player is changed into a code free condition, the optical disc cannot be played back unless its playback is allowed for all regions. Accordingly, it is possible to more efficiently achieve region-based copyright protection for high-density optical discs.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

What is claimed is:

1. A high-density recording medium, comprising:
at least one playback allowance code, which is adapted to determine region-based allowance of playback of data recorded on the recording medium, while being recorded in a part of user control data, having a predetermined recording size, recorded on the recording medium.

2. The high-density recording medium according to claim 1, wherein an address unit number or user data is recorded in a procedure of manufacturing the recording medium or recording data on the recording medium, the address unit number or user data being in a state of being scrambled by being logically combined with said at least one playback allowance code scrambled.

3. The high-density recording medium according to claim 2, wherein said at least one playback allowance code comprises a code for a playback-allowed region, while the code being recorded with a playback allowance code value used, in a scrambled state, to be logically combined with the address unit number or user data.

4. The high-density recording medium according to claim 2, wherein said at least one playback allowance code comprises a code for a playback-inhibited region, while the code being recorded with an optional value other than a playback allowance code value used, in a scrambled state, to be logically combined with the address unit number or user data.

5. The high-density recording medium according to claim 1, wherein the playback allowance code is used to de-scramble the address unit number or user data when the recording medium is played back.

6. The high-density recording medium according to claim 1, wherein the playback allowance code is recorded in a part of the user control data.

7. A method for reproducing data of a high-density recording medium, comprising the steps of:
(A) identifying region identification information stored in a recording/reproducing apparatus, and detecting a region-based playback allowance code, corresponding to the identified region identification information, from user control data recorded on the recording medium; and
(B) de-scrambling a scrambled address unit number read from the optical disc, based on the detected playback allowance code, and performing a data reproducing operation by referring to the de-scrambled address unit number.

8. The region-based data reproducing method according to claim 7, wherein the region identification information is intrinsic region identification information for a region where the recording/reproducing apparatus is to be sold and used.

9. The region-based data reproducing method according to claim 7, wherein the step (B) comprises the step of logically combining the detected playback allowance code with the scrambled address unit number read from the recording medium, thereby de-scrambling the scrambled address unit number into an original address unit number.

10. A method for reproducing data of a high-density recording medium, comprising the steps of:
identifying region identification information previously stored in a recording/reproducing apparatus, and detecting a region-based playback allowance code, corresponding to the identified region identification information, from user control data recorded on the recording medium; and
de-scrambling a scrambled user data read from the recording medium, based on the detected playback allowance code, and performing a reproducing operation.

11. A method for reproducing data of a high-density recording medium, comprising the steps of:
(A) comparing a region-based playback allowance code from user control data recorded on the recording medium with a predetermined code set in a recording/reproducing apparatus; and
(B) determining whether or not to de-scramble a scrambled user data based on the comparing result.

12. A method of claim 11, wherein the scrambled user data is de-scrambled only when the region-based playback allowance code is equal to the predetermined code.

13. A method of claim 11, wherein the selected region-based playback allowance code has at least two kinds of codes.

14. A method of recording data on a high-density recording medium, comprising the steps of:
(A) selecting a region-based playback allowance code in order to restrict a playback, the region-based playback allowance code being unique to at least one region; and
(B) scrambling a user data or an address unit based on the selected region-based playback allowance code.

15. A method of claim 14, further comprising the step of:
(C) recording the scrambled user data or address unit with the selected region-based playback allowance code on the high-density recording medium.

16. A method of claim 14, wherein the selected region-based playback allowance code has at least two kinds of codes.

17. A method of recording data on a high-density recording medium, comprising the steps of:
(A) selecting a region-based playback allowance code in order to restrict a playback, the region-based playback allowance code being unique to at least one region;
(B) scrambling a user data or an address unit based on the selected region-based playback allowance code; and
(C) recording the scrambled user data or address unit, and non region-based playback allowance code along with the selected region-based playback allowance code on the high-density recording medium.

18. A high-density recording medium, comprising:
at least one playback allowance code, which is adapted to determine region-based allowance of playback of data recorded on the recording medium, while being recorded in a part of user control data and being used for scrambling or de-scrambling of user data or address unit data recorded on the recording medium; and
at least one no playback allowance code.
